(19) United States
(12) Patent Application Publication
(10) Pub. No.: US 2002/0101708 A1
(43) Pub. Date: Aug. 1, 2002

(54) Hard disk drive extracting and fixing device

(76) Inventor: Kuang Jui Cheng, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/769,479

(22) Filed: Jan. 26, 2001

(51) Int. Cl. G06F 1/16

(52) U.S. Cl. 361/685

(57) ABSTRACT

A hard disk drive extracting and fixing device is disclosed. The hard disk drive extracting and fixing device mainly includes a body, a lock, a press cover, an outer plate, two elastic elements and an inner plate. The outer plate covers on the inner plate. Two plates are connected through a stud. A plurality of vents are formed on the plates. Two plates have a plurality of vents for heat dissipation. The outer plate is controlled by the press cover. After the press cover is pressed, one end of the outer plate will eject outwards. The ejected end of the outer plate serves as a pull rod and then the hard disk drive can be extracted out from the computer mainframe. Thereby, a hard disk drive extracting and fixing device is formed.

### FIELD OF THE INVENTION

The present invention relates to a hard disk drive extracting and fixing device, and especially to a hard disk drive extracting and fixing device which is fixed, assembled and detached without needing screws and is suitable to be used in the servo of an industrial computer.

### BACKGROUND OF THE INVENTION

The function of a hard disk is used to store a large amount of data. Most of data is stored in a hard disk. Most of data in running is read from the hard disk. However, the general hard disk drive and other devices are fixed to the computer mainframe by a large amount of screws. The assembly and detaching works are inconvenient and much time and cost are required.

Therefore, it is known that the prior art hard disk drive extracting and fixing device is inconvenient in assembly and using and is necessary to be improved.

### SUMMARY OF THE INVENTION

Accordingly, the primary object of the present invention is to provide a hard disk drive extracting and fixing device. The hard disk drive extracting and fixing device is fixed, assembled and detached without needing screws and thus no problem of thread destroy occurs. The cost is low and resource is saved.

Another object of the present invention is to provide a hard disk drive extracting and fixing device, thereby, the user can assembly by himself (or herself). The computer casing will not be destroyed.

A further object of the present invention is to provide a hard disk drive extracting and fixing device suitable to be used in the servo of an industrial computer. The hard disk drive extracting and fixing device mainly includes a body, a lock, a press cover, an outer plate, two elastic elements and an inner plate. The outer plate covers on the inner plate. Two plates are connected through a stud. A plurality of vents are formed on the plates. Two plates have a plurality of vents for heat dissipation. The outer plate is controlled by the press cover. After the press cover is pressed, one end of the outer plate will eject outwards. The ejected end of the outer plate serves as a pull rod and then the hard disk drive can be extracted out from the computer mainframe. Thereby, a hard disk drive extracting and fixing device is formed.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 1A is a perspective view of the press cover in the present invention.

FIG. 2 is an assembled perspective view of the present invention.

FIG. 3 is a cross sectional view of the present invention.

FIG. 4 is a cross sectional view of the present invention.

### DETAILED DESCRIPTION OF THE PREFERRED EMBODIMENTS

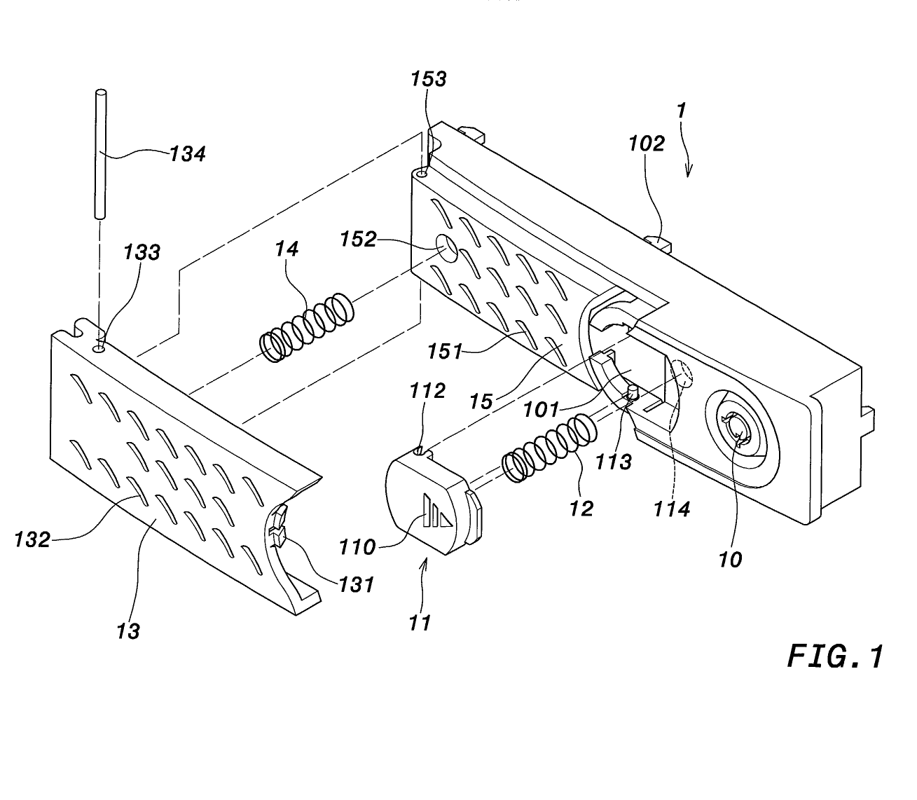

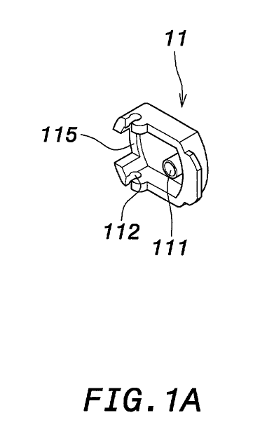

Referring to FIGS. 1 and 1A, the hard disk drive extracting and fixing device according to the present invention is provided, wherein no screw is necessary in fixing, assembling and detaching. The present invention is suitable to the hard disk drive of an industrial computer. The hard disk drive extracting and fixing device of the present invention includes a body 1, a plurality of hooks 102 at the lateral sides of the body 1. The hook 102 serves to hook the casing (not shown) of the hard disk drive. The body 1 is installed with a lock 10 therein. The lock 10 may perform the actions locking or opening with a key. A connecting slot 101 is installed at an outer side of the lock 10 of the body 1. The connecting slot 101 is installed with two posts 112 therein. The post 113 is connected to a press cover 11. A front side of the press cover 11 is installed with protruded texture 110.

Thereby, the indication of the press cover 11 can be performed conveniently. A rear side of the press cover 11 is installed with a post 111. The post 111 is engaged with an elastic element 12. One end of the elastic element12 is embedded into the retaining seat 114 of the body 1. The rear surface of the press cover 11 is installed with two grooves 112. Each groove 112 is fixed to the two posts 113 in the body 1. A hole groove 115 is installed near the press cover 11. An outer plate 13 is installed at the outer side of the press cover 11. One end of the outer plate 13 is installed with a hook 131. The hook 131 is buckled to the hole groove 115 near the edge of the press cover 11. A front surface of the outer plate 13 is formed with a plurality of vents 132. The vents 132 serve to be passed by air so as to increase the heat dissipation effect.

A distal end of the outer plate 13 is installed with a groove 133. The groove 133 can be connected to a stud 134. The rear surface of outer plate 13 is further installed with an elastic element 14. The outer plate 13 covers on the inner plate 15. The inner plate 15 is connected to the body 1. The body 1 is integral formed. The front surface of the inner plate 15 is installed with vents 151. To prevent the isolation of the airflow, each vent of the inner plate 15 is correspondent to the vent 132 at the front surface of the vent 132. The center of the front surface of the inner plate 15 is installed with a retaining seat 152. The retaining seat 152 may be contained with elastic element 14. The tail of the top of the inner plate 15 is installed with a groove 153. The groove 153 passes through the stud 134 to be connected to the outer plate 13.

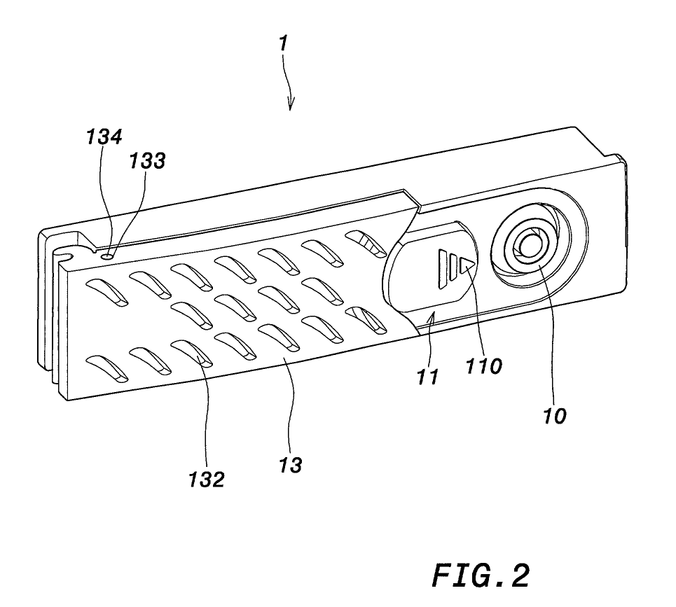

Referring to FIGS. 1, 1A and 2, when the hard disk drive extracting and fixing device is desired to be used, at first, the elastic element 12 is buried to the retaining seat 114 of the body 1, and one end of the elastic element 12 is engaged with the post 111 at the rear surface of the press cover 11. Then the grooves 112 at the rear side of the press cover 11 are connected and fixed to the posts 113 in the body 1. Then, the elastic element 14 is buried into the retaining seat 152 at the front surface of the inner plate 15. One end of the elastic element 14 is fixed to the rear surface of the outer plate 13. Then, the outer plate 13 covers on the inner plate 15. After covering, it will align with the groove 133 at the tail portion of the top of the inner plate 15. Then, the stud 134 passes through the groove 133 of the outer plate 13 and the groove 153 of the inner plate 15. Finally, a plurality of hooks 102 are circularly installed at the lower end of the body 1 so as to be connected to the casing of the hard disk drive and thus the assembly of all parts is accomplished.

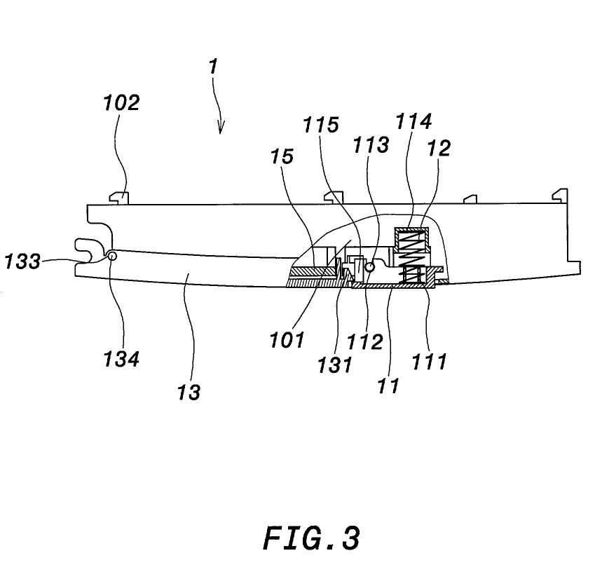

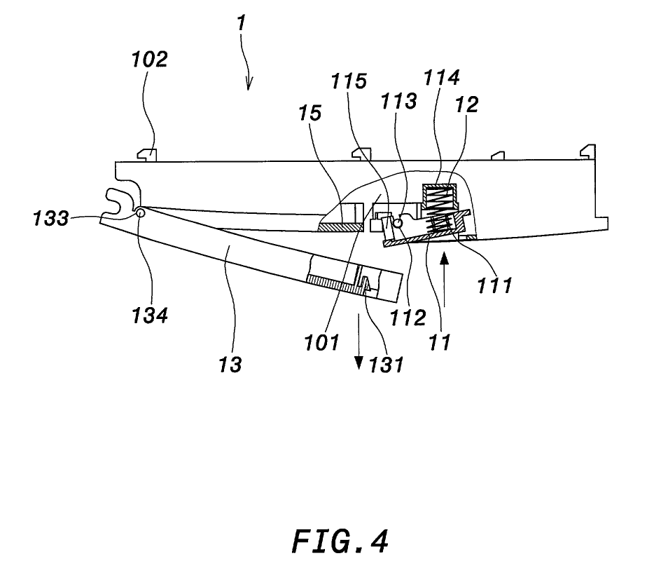

Referring to FIGS. 3 and 4, if the casing of a hard disk drive is separated with the computer mainframe (not shown), the indication texture 110 is formed on the front face of the press cover 11. The user may operate according to the action of the texture to press the press cover 11. When the press cover 11 is operated due to the pressure from the user, a hole groove 115 at the rear side of the press cover 11 will tilt. The hook 131 connected to the outer plate 13 will separate with the hole groove 115 due to the operation of the press cover 11. The outer plate 13 will eject upwards due to the elastic element 14 at the rear side of the outer plate 13. Since the tail at the top of the outer plate 13 and the inner plate 15 is connected to the stud 134. Therefore, the ejected outer plate 13 will be inclined. One end of the ejected and inclined outer plate 13 may be used as a pull rod so that the hard disk drive can be successfully extracted to be out of the computer mainframe. Therefore, a hard disk drive extracting and fixing device according to the present invention is formed,

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A hard disk drive extracting and fixing device comprising:
a body having a lock and a hole groove at a front surface thereof, posts and a first retaining seat being installed within the hole groove, a rear side of the body being circularly installed with a plurality of hooks; an inner plate being extended from a front surface thereof; a second retaining seat being installed at a center near a tail end of a front surface of the inner plate; and a tail of the top thereof being installed with a groove;
a press cover being installed in the hole groove of the body; a rear surface thereof being installed with a post and two grooves, the grooves being connected to the post; and a hole groove being installed near an edge thereof;
an outer plate covering on the inner plate; a hook at one end being buckling to the hole groove, and another end being installed with a groove for being connected to the inner plate; a stud passing through the groove in the inner plate and the groove in the outer plate; and
two elastic elements being installed between the retaining seat of body and between the retaining seat of the inner plate and the rear surface of the outer plate.

2. The hard disk drive extracting and fixing device as claimed in claim 1, wherein the body, press cover and outer plate are made of plastics and by injection molding.

3. The hard disk drive extracting and fixing device as claimed in claim 1, wherein the hooks are hooked to the casing of a hard disk drive.

4. The hard disk drive extracting and fixing device as claimed in claim 1, wherein indication textures are formed on the press cover for indicating actions of the press cover.

5. The hard disk drive extracting and fixing device as claimed in claim 1, wherein a plurality of vents are installed on the outer plate and the inner plate for venting air so as to increase a heat dissipating effect.

6. The hard disk drive extracting and fixing device as claimed in claim 1, wherein one end of the outer plate is used as an extractable pull rod.
